(19) United States
(12) Patent Application Publication
(10) Pub. No.: US 2013/0266131 A1
(43) Pub. Date: Oct. 10, 2013

(54) VOICE CONFERENCE REDUNDANCY

(71) Applicant: INFINET FINANCIAL SYSTEMS, NEW YORK, NY (US)

(72) Inventor: HUW RICHARD WILLIAMS, New York, NY (US)

(73) Assignee: INFINET FINANCIAL SYSTEMS, NEW YORK, NY (US)

(21) Appl. No.: 13/860,419

(22) Filed: Apr. 10, 2013

Related U.S. Application Data
(60) Provisional application No. 61/622,216, filed on Apr. 10, 2012.

(51) Int. Cl. H04M 3/56

(52) U.S. Cl. CPC H04M 3/568
USPC 379/202.01

(57) ABSTRACT

A voice conferencing system provides redundant audio signal mixer modules to prevent loss of audio signals during a teleconference. The audio signal mixer modules may process audio signal data concurrently. In some embodiments, one of the audio signal mixer modules may playback streaming audio data while other audio signal mixer modules are muted. Upon malfunction of the audio signal mixer module designated for playback, another audio signal mixer module may be unmuted so that transmission of audio data during the teleconference occurs seamlessly.

### CROSS REFERENCE TO RELATED APPLICATIONS

This application claims benefit under 35 U.S.C. §119(e) of U.S. Provisional Application No. 61/622,216 filed Apr. 10, 2012, which is hereby incorporated by reference herein in its entirety.

### BACKGROUND OF THE INVENTION

The present invention generally relates to communication system and more particularly, to voice conference redundancy.

In conventional teleconference systems, each entity participating in the teleconference typically contacts a central hub (sometimes called a conference bridge) where the hub manages the teleconference. Audio data from each participant may be routed through the hub where processing of the audio data, if any, occurs. The audio output may be re-directed to each of the participants. The quality of the audio signaling received at each endpoint may be dependent on the reliability of the hub to receive and process the audio data, and then transmit the mixed audio data. Losses in the receipt, processing and transmission of audio data may thus appear as lapses in audio signals to one or more participants on the call. In some cases, for example, during a bidding transaction or investment trading conferencing, even a few seconds may have severe financial implications.

As may be seen, there is a need for providing teleconferencing with reliable and seamless endpoint to endpoint transmission of audio data.

### SUMMARY OF THE INVENTION

In one aspect of the present invention, a system comprises a plurality of terminals. The terminals may be adapted for voice conferencing. Each terminal may include a controller configured to provide a peer-to-peer connection to other terminals in a conference call. A pair of audio signal mixer modules may be connected to the conference call. The controllers may be configured to cooperate to manage the pair of audio signal mixer modules concurrently during the conference call. The pair of audio signal mixer modules may be configured to playback audio streams of audio data received from the plurality of terminals.

In another aspect of the present invention, an apparatus may comprise a user interface; a communication interface port adapted to transmit and receive audio data signals; a plurality of audio signal mixer modules configured to process audio data signals; and a controller including, a processing device configured to communicate with other terminals, to cooperatively control the plurality of audio signal mixer modules to operate concurrently and simultaneously with one another, and send the processed audio data as audio streams to an audio output module, and memory storing instructions configured for execution by the processing device.

In yet another aspect of the present invention, a computer program product for managing a voice conference between terminals, the computer program product comprising a computer readable storage medium having program code embodied therewith. The program code may be readable/executable by a processor to: send a request for a teleconference call from a first terminal to a second terminal; provide a peer-to-peer connection between the first and second terminal and any audio signal mixers either on one of the terminals or separate hardware or virtualized platform; process audio signal data transferred between the first and second terminals through at least two audio signal mixer modules through the peer-to-peer connections; and provide the processed audio signal data to listeners interfaced with the first and second terminals.

These and other features, aspects and advantages of the present invention will become better understood with reference to the following drawings, description and claims.

### BRIEF DESCRIPTION OF THE DRAWINGS

FIG. 1 is a schematic diagram of a system for audio teleconferencing utilizing two redundant mixers according to an exemplary embodiment of the present invention;

FIG. 2 is a block diagram of a terminal used in the system 100 of FIG. 1;

FIG. 3 is a block diagram of a peer-to-peer connection according to another exemplary embodiment of the present invention; and

FIG. 4 is a flow chart of a method of providing a teleconference according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a reliability and quality optimization mechanism for voice conferencing to maximize voice quality, availability and up-time. This may be particularly applicable to a trading room or command and control environment. In general, redundant audio signal mixer modules (e.g. voice mixers) may be part of a standalone conferencing system, part of a more specific Voice over IP (VoIP) solution such as the Adaptive Trading Platform (ATP), or part of a trading room or command and control voice platform.

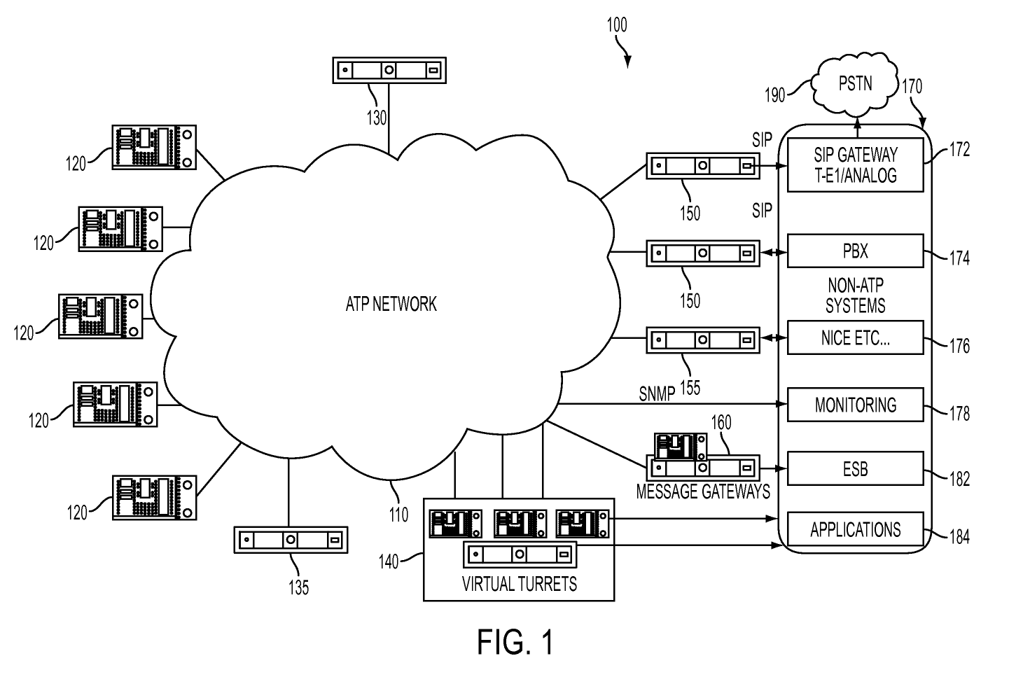

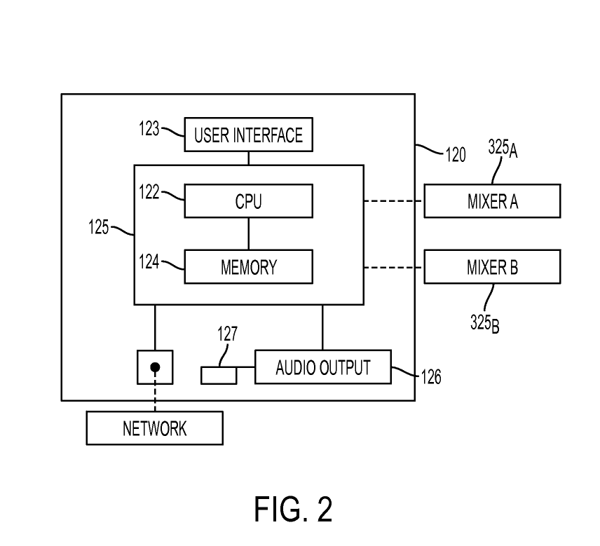

Referring now to FIGS. 1-3, a system 100 (FIG. 1) for audio teleconferencing is shown according to an exemplary embodiment of the present invention. A terminal 120 (FIG. 2) is shown in accordance with an exemplary embodiment of the present invention. A peer-to-peer connection 300 (FIG. 300) is shown according to an exemplary embodiment of the present invention. A plurality of terminals 120 may be connected via a network 110. The terminals 120 may sometimes be called turrets, for example, in the context of a trader console. Details of the terminals 120 will be described below. The network 110 may be any communications system employing for example hardware lines and/or radio signals to transmit and receive data.

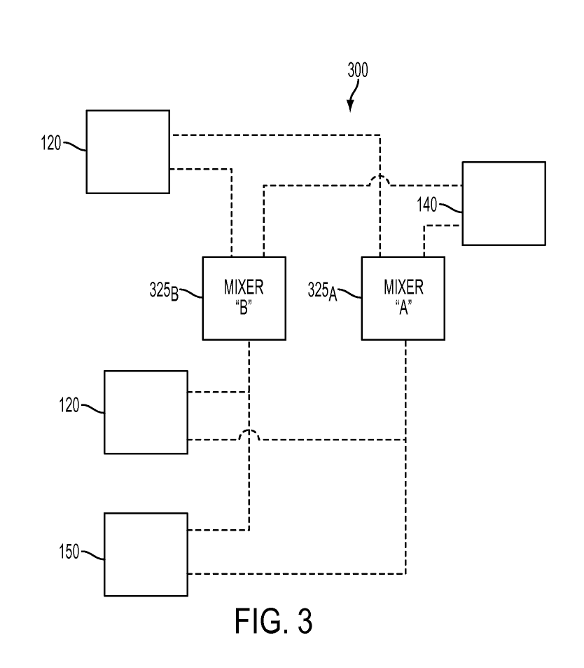

In an exemplary embodiment, the system 100 may employ redundant audio signal mixer modules 325_{A} and 325_{B} (referred to generally as audio signal mixer modules 325) on a call configured to process audio data signals simultaneously. Although two audio mixer modules 325 are shown, it will be understood that devices in the system 100 may employ more than two audio mixer modules depending on the processing and memory capacity of their respective computing boards. Some embodiments of the present invention may be computer readable programs and computer executable instructions stored on for example, non-transitory computer readable mediums. For example, the audio signal mixer modules 325 may, in some embodiments, be entirely software (computer readable programs and computer executable instructions) stored on any of the devices in the system 100. While FIG. 3 shows devices 120, 140 and 150 connected to audio signal mixer modules 325, it will be understood that any device connected to a teleconference may be connected to both of the audio signal mixer modules 325_{A} and 325_{B} during a call. In an exemplary embodiment, one of the audio mixer modules 325 (for example audio mixer module 325_{A}) may provide audible processed audio data to devices connected to the call while the other audio mixer module 325 (for example audio mixer module 325_{B}) is muted while simultaneously processing the audio data. In the event, the audio mixer module 325_{A} suffers any fault or significant degradation in performance in processing or playback, the audio mixer module 325_{B} may become partly or fully unmuted and may seamlessly provide the audio playback to some or all of the devices on the call.

The computer readable programs and computer executable instructions may use an IP telephony protocol represented by the acronym “SIP”. Data entering the network 110 from the public switched telephone network (PSTN) 190 may be processed by the SIP (or other similar voice protocol) compatible computer readable programs and computer executable instructions for use by the terminals 120 and other devices connected to the network 100 as described below in teleconferencing applications.

Data being transferred through the network 110 may use the real-time transport protocol (RTP). In some embodiments, the system 100 may be configured to process ATP data through the network 110. The network 110 may be connected to the PSTN 190 through ATP gateways 150, a voice recording gateway 155 and message gateways 160. A bank 170 of data exchange modules (172; 174; 176; 178; 182; 184) may translate and carry data from respective interfaces with the network 110 to the PSTN 190. While “SIP” protocol is shown associated with gateway servers 150, it will be understood that the associated computer readable programs and computer executable instructions including the audio mixer modules 325_{A} and 325_{B} may be resident on the other devices connected to the network 110.

In an exemplary embodiment, the terminals 120 may be connected together in a peer-to-peer fashion. Thus, audio signals may be sent directly from and received directly by each of the terminals 120 participating in a teleconference. It may be appreciated that by using a peer-to-peer connection, the failsafe aspect of the redundant audio signal mixer modules 325 is distributed rather than relying on a centralized bridge where failure may bring an entire call to an abrupt end.

When bringing a terminal 120 into the system 100, the terminal 120 may be connected to a configuration server 130. The configuration server 130 may store computer readable programs and data, and computer executable instructions which may be loaded into the terminal 120 allowing it to communicate with other terminals 120.

In some embodiments, the system 100 may include a morning call server 135, for example, in applications where the system 100 is used for large scale conferencing for trading. The morning call server 135 may employ both a two-way transmission and a one-way broadcast or multi-cast transmission of audio data to the terminals 120.

In an exemplary embodiment, the system 100 may include virtualized terminals 140. The virtualized terminals 140 may be software applications run on an electronic platform that is not a dedicated terminal 120. For example, the virtualized terminals 140 may be programs run on a PC, a mobile phone, a tablet or other computing device with a user interface. The terminals 120 may be configured to communicate with the virtualized terminals 140 as though the virtualized terminals 140 were terminals 120.

The terminal 120 may include: a communication interface port 121 adapted to transmit and receive audio data signals; a user interface 123; and a controller 125. The controller 125 may include a processing device 122 (e.g. a processor or CPU) and memory 124 storing instructions configured for execution by the processing device 122. The processing device 122 may be configured to control audio signal mixer modules 325 to operate concurrently and simultaneously with one another, and provide the processed audio data as audio streams to audio output modules 126 in this and other terminals 120 on the conference call. The audio output module 126 may provide the processed audio data to an output interface 127 (e.g. a speaker). In some embodiments, each terminal 120 participating on a call may designate one of the audio signal mixer modules 325 available for a call as a primary mixer “A” (e.g. mixer 325_{A}). Another of the audio signal mixer modules 325 available to the terminal 120, (typically on a different terminal 120 in network 110) may be designated as a secondary mixer “B” (e.g. mixer 325_{B}). The primary mixer 325 may be designated as providing playback of audio data streams processed by the mixers 325 while the secondary mixer 325 may be designated to be muted for playback during processing. From a virtual perspective, each of the terminals 120 on a call may be receiving processed audio playback from the same primary mixer 325 (FIG. 3). Thus, audio data may be consistent for each terminal and all participants on the call may expect to hear the same audio signal with the same signal integrity and quality. In the event the playback (primary) mixer 325 malfunctions (e.g. stops operating, becomes overwhelmed with data traffic, loses call capacity, etc.) the other mixer 325 may become unmuted for playback upon detection of the malfunction. It may be appreciated that detection may occur nearly instantaneously and transition between the primary mixer 325 to the secondary mixer 325 may be undetectable by a participant on the call. In some embodiments, the transition between the primary mixer 325 and the secondary mixer 325 may occur at different times or not at all for different terminals 120 depending on the operating behavior of each terminal 120 and the relative performance of primary mixer 325 and secondary mixer 325.

In some embodiments, the audio signal mixer modules 325_{A} and 325_{B} may be configured to process audio signal data from multiple teleconferences simultaneously. For example, a user at one of the terminals 120 may participate in one main teleconference while also be connected to one or more sub-teleconferences with individuals discussing the main teleconference. In some embodiments, if one of the audio signal mixer modules 325_{A} and 325_{B} is at capacity to handle more incoming call traffic, another audio signal mixer module 325 may be setup to work with one of the pre-existing audio signal mixer modules 325 to handle the new call.

The controllers 125 may real-time monitor the conference checking various parameters to identify the relative performance of the mixers 325 currently mixing the call. Parameters may include the presence or otherwise of the RTP stream from the mixers 325, packet loss, latency and jitter measurements of the RTP stream, parameters captured from the RTCP stream that accompanies the RTP stream, and the number of participants being mixed by each mixer 325. For example, a mixer 325 handling a lower number of participants than other mixers 325 may indicate inferior mixer performance. These parameters may be weighted and used to determine from which mixer 325 the RTP stream should be played back from.

When deciding which of the redundant mixers 325 to playback from, and whether to switch playback to a different mixer 325, the controller 125 may include logic in an algorithm to avoid flapping or continuously switching between mixers 325. This logic may determine that the performance difference between the mixer 325 to be switched from and the mixer 325 to be switched to, be above an optimized trigger level.

In some embodiments, the mixer 325 may conference or mix anywhere from two to many hundreds of voice streams simultaneously. In addition, the mixer 325 may need to stream extra RTP streams to IP voice loggers. The mixer 325 may run acoustic echo cancellation and deal with other audio processing work such as wide bandwidth CODEC's, compression, volume control, and muting, for example.

In operation, at least 2 audio signal mixer modules 325 may be in concurrent simultaneous operation, mixing the same logical voice streams in parallel, or as close to parallel as possible. If a mixer 325 whose voice stream is being played back from fails, then the controller(s) 125 that are playing that stream back may switch the playback to a stream from one of the other concurrent mixers 325. This may happen rapidly, ideally so that a listener loses little or none of the stream. In some embodiments, if an active mixer 325 fails, then one of the controllers 125 s (or some other monitoring process) may either activate a new mixer 325 on the call or bring an already started active but available mixer 325 into the call. Thus, the switching process between mixers 325 providing processed audio data may be transparent to the callers.

According to some exemplary embodiments, the redundant mixers 325 may be used in environments including a voice recording server, a voice gateway, a hardware based turret, a software based turret, an audio mixing component, and turret download profiles, for example.

A mixer may use the SIP, H323 or other VoIP protocol to setup calls and other similar VoIP protocols could be used. Voice streams can originate from internal sources such as turrets (physical and virtual), phone handsets, mobile devices, automated systems such as IVRs or sound sources (MOH, tone generators etc), or gateways connected to external PSTN gateways (using such protocols as T1, E1, PRI, BRI or analog), or to session boundary controllers (SBCs) connecting to remote voice networks.

The mixers 325 may run embedded Linux and may be managed via HTTPS, and monitored via SNMP. The mixers 325 may also run concurrently (i.e. on the same hardware or virtual platform) with gateway, turret, voice recording or other functions embedded in the hardware.

In some embodiments, the mixers 325 may run on servers running Linux and deployed as Linux appliances. The servers may operate on x86-based machines and may be accessible via https interfaces for management, which may lock down the Linux appliance from a security perspective. The Linux appliance may also be deployed as a VMWare vmdk file, or AMI image in a server cloud environment.

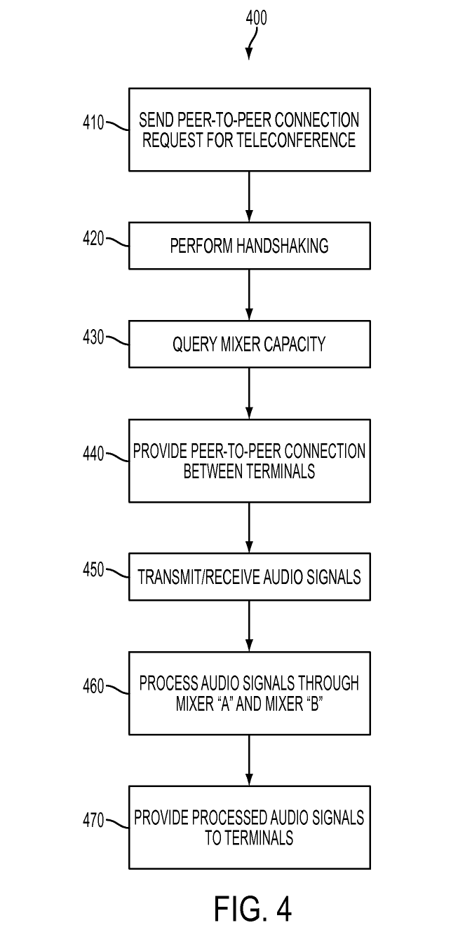

Referring now to FIG. 4, a method 400 of providing a teleconference is shown according to an exemplary embodiment of the present invention. It will be understood that the numbered blocks may be executed as actions performed by the processing device 122 according to the computer executable steps in the memory 124. In some embodiments, one terminal 120 may initiate the teleconference and thus, the controller 125 of the initiating terminal 120 may coordinate the following steps in cooperation with controllers 125 of respective terminals 120 participating in the teleconference. In block 410, the controller 125 may send a request to terminals 120 to participate in the teleconference. In some embodiments, only select terminals 120 may be invited or allowed to participate instead of all terminals 120 connected to the network 110. The participating terminals 120 may be connected in peer-to-peer fashion. In block 420, the controller 125 may perform handshaking between the terminals 120 invited to or otherwise participating in the teleconference. In block 430, the controller 125 may query the terminals 120 or other platforms in network 110 that have audio signal mixers 325 for mixer capacity. For example, each of the audio signal mixer modules 325 in respective terminals 120 may be checked for availability (memory or processing capacity) to handle data traffic for an incoming teleconference. In an exemplary embodiment, a terminal 120 may need two audio signal mixer modules 325 available before participating in the teleconference. In block 440, the controller 125 may provide a peer-to-peer connection among invited terminals 120. In block 450, the controller 125 may coordinate transmission and receipt of audio signal traffic between terminals 120. In block 460, the controller 125 may process audio signal data through two or more audio signal mixer modules. In block 470, the controller 125 may provide processed audio signal data from respective terminals 120 to listeners interfaced on other terminals 120 in the teleconference.

It should be understood, of course, that the foregoing relates to exemplary embodiments of the invention and that modifications may be made without departing from the spirit and scope of the invention as set forth in the following claims.

What is claimed is:

1. A system, comprising:
a plurality of terminals, the terminals adapted for voice conferencing;
a controller in the terminals, the controller configured to provide a peer-to-peer connection between the terminals in a conference call; and
a pair of audio signal mixer modules connected to the conference call, wherein the controllers are configured to operate the pair of audio signal mixer modules concurrently during the conference call and wherein the pair of audio signal mixer modules are configured to playback audio streams of audio data received from the plurality of terminals.

2. The system of claim 1, wherein playback from one of the audio signal mixer modules is muted until the other audio signal mixer module is unable to playback an audio stream.

3. The system of claim 1, wherein the controllers are configured to cooperate to provide an invitation to select ones of the plurality of terminals to join the conference call.

4. The system of claim 1, wherein the pair of audio signal mixer modules is resident as software modules connected to the conference call.

5. An apparatus, comprising:
a user interface;
a communication interface port adapted to transmit and receive audio data signals;
a plurality of audio signal mixer modules configured to process audio data signals received by the communication interface port; and
a controller including,
a processing device configured to control the plurality of audio signal mixer modules to operate concurrently and simultaneously with one another, and provide the processed audio data as audio streams to an audio output module, and
memory storing instructions configured for execution by the processing device.

6. The apparatus of claim 5, wherein the controller is configured to provide a peer-to-peer connection with a terminal.

7. The apparatus of claim 5, wherein the controller is configured to provide the peer-to-peer connection to a virtualized terminal.

8. A computer program product for managing a voice conference between terminals, the computer program product comprising a computer readable storage medium having program code embodied therewith, the program code readable/executable by a processor to:
send a request for a teleconference call from a first terminal to a second terminal;
provide a peer-to-peer connection between the first and second terminal;
process audio signal data transferred between the first and second terminals through at least two audio signal mixer modules through the peer-to-peer connection; and
provide the processed audio signal data to listeners interfaced with the first and second terminals.

9. The computer program product of claim 8, the program code being readable/executable by the processor to:
provide the processed audio signal data from a first of the audio signal mixer modules, and
switch to a second of the audio signal mixer modules to provide the processed audio signal data upon malfunction of the first of the audio signal mixer modules.

10. The computer program product of claim 8, the program code being readable/executable by the processor to determine whether the first and second terminals have audio signal mixer processing availability to process the teleconference call before providing the peer-to-peer connection.
